(19) United States
(12) Patent Application Publication
(10) Pub. No.: US 2008/0098313 A1
(43) Pub. Date: Apr. 24, 2008

(54) SYSTEM AND METHOD FOR DEVELOPING AND MANAGING GROUP SOCIAL NETWORKS

(75) Inventor: Daniel Pollack, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: INSTABUDDY LLC, Mesa, AZ (US)

(21) Appl. No.: 11/747,816

(22) Filed: May 11, 2007

Related U.S. Application Data
(60) Provisional application No. 60/862,546, filed on Oct. 23, 2006.

(51) Int. Cl. G06F 3/00

(52) U.S. Cl. 715/753

(57) ABSTRACT

A system and method for facilitating the configuration and management of events within a social networking system is disclosed. The system enables members of similar or different geographic region and/or like interests, hobbies, social status, relationship status, family status, etc. to interact with the system to view activities, register to participate in activities, and schedule activities. A personal workspace, accessible through a variety of devices (e.g., kiosks, web clients, wireless devices, and set-top boxes) enables network members to view a personal calendar, scheduled events and activities, invitations, localized news, and the like. The personal workspace further facilitates registration to participate in scheduled activities. A scheduling interface enables network users to configure and schedule activities through selection and/or entry of an activity details. The system further interacts with other systems to determine facility availability, facility costs, payment processing, perform background checks, synchronize calendars and contact lists, and the like.

### CROSS REFERENCE TO RELATED APPLICATIONS

This application claims priority to, and the benefit of, U.S. Provisional Application Ser. No. 60/862,546, filed Oct. 23, 2006 and entitled “System and Method for Developing Group Social Networks”, which is hereby incorporated by reference in its entirety.

### FIELD OF THE INVENTION

This invention generally relates to a social networking management system, and more particularly, to a system which groups individuals sharing common interests into a social network, wherein each member may schedule events and/or register for event participation.

### BACKGROUND OF THE INVENTION

Human beings have always craved deeper and more meaningful personal connections with others. In their constant efforts to develop these connections, many methods for connecting people in social environments have been created. Before significant technological advancements, newsletters and bulletin boards were used to notify people, groups, committees, clubs, societies and organizations about upcoming events, programs, new members and other relevant information.

Through recent technological advancements, including the Internet, intranets, email, and mobile communication devices, newer and more advanced forms of communication have become available for trying to keep large groups of people informed about common interests. One such avenue has been online social networking websites which connect people through chat rooms and personal profiles. However, these websites do not sufficiently replace the human need for direct and personal communication and interaction. Because these websites target some specific segments of the marketplace, the websites leave out a majority of the population who may be uncomfortable sharing or communicating their meeting requests or activities with numerous unknown people over the Internet. Additionally, these sites do very little to foster personal communication. Instead, the websites merely try to replace face-to-face meetings, which could potentially have the reverse anticipated affect of further isolating users from engaging in live interactions.

Another technological advancement that has become popular through the Internet has been the process of inviting defined people to an event or meeting. Through different mediums (e.g., a website, an email or another software product), individuals can electronically invite already-identified people to a specified event or meeting. This existing technology allows users to view information about the people who will be attending the event and information about people who have declined to attend. While these technologies offer an alternative to paper invitations, they are limited to inviting only people who are already known to the person initiating the event or meeting. Additionally, these technologies are only Internet and/or computer based, and they are cumbersome, time-consuming and potentially confusing to the users.

All these factors, among others, make the existing social interaction technology inappropriate and unwelcome for use by those who desire to organize a social outing with like minded people. Despite all these technological advancements, two or more people, unknown to each other, who have geographic similarities and a desire to participate in like activities, still have a small chance of meeting each other, and an even smaller chance of meeting for the purpose of engaging in an activity they both enjoy.

### SUMMARY OF THE INVENTION

The present invention addresses the disadvantages of other systems by combining and improving known technologies to create a public/private network coupled with a device that aids in developing group social networks. In one embodiment, the system connects people directly and personally with others in a particular region for the purpose of actively participating in similar interests, hobbies and activities. The Social Networking System (SNS) terminal system functions as an in-home or mobile bulletin-board for specific geographic regions, such as communities, clubs, buildings or neighborhoods. The SNS terminal system helps bring people together, who were previously unknown to one another, but who have interests in common such as geographic location, activity interests, and other personality interests.

In an exemplary embodiment, the networked devices are located or installed in users' dwellings, e.g., homes, town homes, condominiums, apartments, etc. The network may be restricted to a specific geographic area such as a neighborhood, development, sub-division, apartment complex, retirement community, college campus or any other defined area. In such a defined area, it is more likely that potential users would have similar interests.

According to another embodiment of the present invention, network users can use the device to suggest activities to all other users in the geographic network, such that the other users can personally participate in the live activity. These activities are created in a variety of ways, for example, the activities may be suggested through a menu of pre-determined categories or the activities may be suggested via direct input of the specific activity by a user. In an exemplary embodiment, each geographic network stores activities that occur in or near the geographic area of the network, and the network also stores information on activities which have been previously inputted or chosen by members of the network.

After the invitation is broadcast across the network, other users are able to accept invitations in real time to participate in these activities. Users then meet at a specified location as determined, for example, by the user which initiated the activity. Activities may be suggested and/or accepted days, hours or minutes before the scheduled time for the activity. Activities as small as group grocery shopping trips or as large as group vacations may be planned and may be suggested by any network user or by the network administrator.

In one embodiment, a method for suggesting or accepting activities employs the SNS terminal device equipped with a touch screen. The device is loaded with software to allow user selections to be menu driven. The device is connected to several databases on the SNS terminal network through, for example, the Internet, through a wireless network, over a local area network, or via any other communication or network system discussed herein or developed in the future. According to another embodiment of the invention, the features available on the device could be general features, and/or the features could be customized for the specific network (i.e., specific neighborhoods, schools, complexes, cities, clubs, buildings, and the like) where an SNS terminal network is in operation.

Specific activities could be suggested, recommended or preferred based on a user's or network's location. For example, if a tennis court existed in a community where an SNS terminal network existed, the device could suggest to a user to schedule a tennis activity, and the user could then schedule a specific time for a game. In the event that the request is accepted by more than one user, the users could convert the game into a doubles-match or tournament. The device additionally has the capability to create a tournament bracket and keep track of the results for the individual games, such that the tournament could be played over a period of days, weeks, months, etc.

In one embodiment of the invention, the devices are permanently or temporarily installed table-top units. The devices could be located in individual users' homes or placed in any number of common areas for multiple users to access. According to another embodiment, the device is a mobile device or the software can be integrated into an existing device (e.g., cell phone, personal digital assistant, laptop computer, alarm system, home electronics device, etc).

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is a block diagram illustrating the major system components for an exemplary system for managing event scheduling and registration, in accordance with an exemplary embodiment of the present invention;

FIGS. 2 is a process flow diagram showing exemplary steps for facilitating the presentation of scheduling and event registration information, in accordance with an exemplary embodiment of the present invention;

FIG. 3 is a screenshot illustrating an exemplary interface for enabling members of a social network to manage an event calendar, in accordance with an exemplary embodiment of the present invention;

FIGS. 4 is a process flow diagram showing exemplary steps for facilitating the scheduling of events, in accordance with an exemplary embodiment of the present invention; and,

FIG. 5 is a screenshot illustrating an exemplary interface for enabling members of a social network to schedule events, in accordance with an exemplary embodiment of the present invention.

### DETAILED DESCRIPTION OF EXEMPLARY EMBODIMENTS

The detailed description of exemplary embodiments describes the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention includes a system and method for developing and managing social networks. As used herein, “social network” or similar phrases may include any grouping of two or more individuals through shared (or different) geographic regions, interests, hobbies, sporting interests, relationship status, race or religious interests, political interests, and the like. The invention includes the facilitation of electronic communication over the Internet or other networking protocol, for the purpose of forming social networks, scheduling activities, joining social networks, registering to participate in activities, and/or the like. For example, some users of the system may be interested in joining networks of the same apartment building, while other users may be interested in joining a network with people of different apartment buildings.

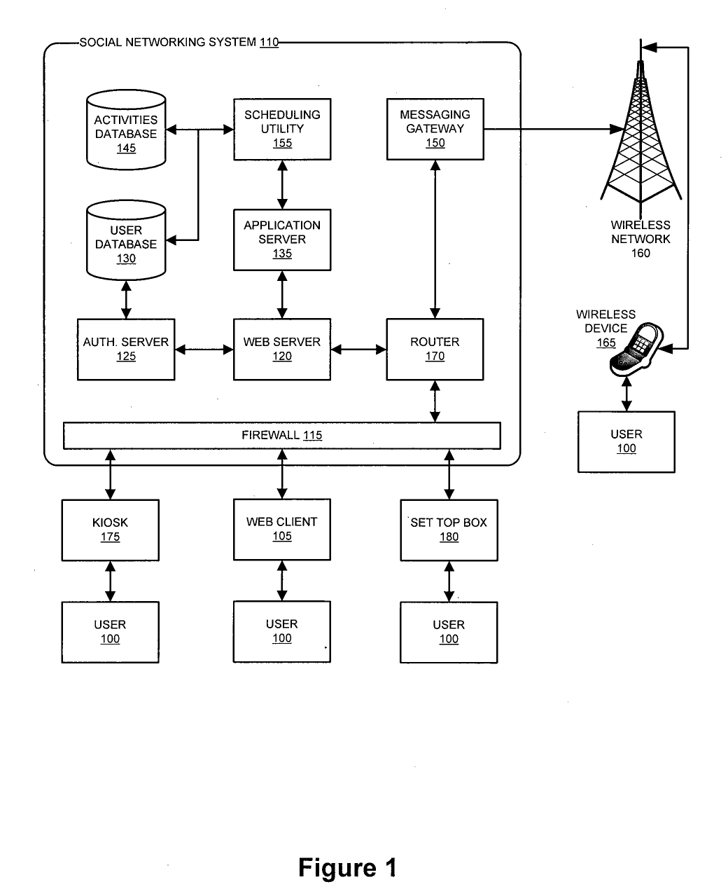

With reference to FIG. 1, the Social Networking System (SNS) 110 facilitates interaction between various users and a scheduling utility 155 through, in one embodiment, a web client 105 with a network connection to a web server 120 for the purposes of, for example, scheduling events, viewing events, and registering to participate in future events. In various other embodiments, user 100 may interact with SNS 110 through a free-standing kiosk 175, set-top box 180, wireless device 165, or any other known method and/or device configured to communicate over an electronic network. As will be described in greater detail herein, such electronic networks may comprise, for example, a LAN, WAN, cellular network, satellite, radio, infrared, and the like.

Web server 120 may employ an authentication server 125 in order to validate and assign proper permissions to authorized users of SNS 110. Web server 120 also employs an application server 135 to manage various applications and utilities that are utilized by SNS 110. In one embodiment, scheduling utility 155 is invoked by application server 135 to query a user database 130 and/or an activities database 145 to retrieve data relating to other users, scheduled events, venues, locations, facilities, and the like. User database 130 stores profiles, credentials and permissions specific to each user 100. In one embodiment, application server 135 interfaces with a report engine (not shown) to create pre-configured and/or ad-hoc reports representing any data elements detailed herein.

User 100 may include any individual, business, entity, government organization, software and/or hardware, which interacts with SNS 110 to plan events, schedule events, view scheduled events, register for participation, receive news updates, and the like. Any existing or developed scheduling, dating, or other social software or website may interface and/or share data with SNS 110. Further, any merchant, organization, informational or social website may interface with SNS 110 such that, for example, SNS 110 may provide weather updates, directions to events, sale of complementary products (e.g., sell hiking shoes on a page that is scheduling a hiking event), traffic updates, and/or the like. In one embodiment, user 100 access to such functionality is dictated according to the location of user 100 (e.g., home address and/or business address), location of the connecting device (e.g., kiosk 175, web client 105, set-top box 180, and wireless device 165), and the like. User 100, for example, may own a home in a neighborhood governed by an association, which regularly schedules events that are exclusively available to neighborhood residents. User 100 may further be an administrator of SNS 110, an event coordinator, an event sponsor, a facilities administrator, a business owner, or any other third-party with an interest in participating with the invention in order to manage, plan, schedule, or participate in social networking activities.

In addition to the components described above, SNS 110 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include user database 130 and activities database 145, as well as any number of other databases, both internal and external to SNS 110 useful in the operation of the invention as disclosed.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

In one embodiment, scheduling utility 155, or any other SNS 190 component, may interact with any number of additional computing systems and databases in order to facilitate, for example, administration, event planning, event scheduling, registration, advertising, and etc. Computing systems and databases residing outside of SNS 110 may be administered by any other third party entity directly or indirectly involved in facilitating the disclosed system. Such third party entities may include governmental organizations, financial institutions, non-profit organizations, small businesses, corporations, and the like.

As will be appreciated by one of ordinary skill in the art, the invention may be embodied as a customization of an existing system, an add-on product, upgraded software, a standalone system (e.g., kiosk), a distributed system, a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In one embodiment, SNS 110 provides limited or restricted access for certain people or groups, such as, for example, clients, employees, or any other third party with an interest in, for example, scheduling and/or participating in social activates, seminars, workshops, entertainment venues, dining, and the like. User 100 may interface with SNS 110 via any communications protocol, device or method discussed herein or known in the art. In one embodiment, user 100 may interact with the invention via an Internet browser at a web client 105, a kiosk 175, set-top box 180, and/or wireless device 165. In another embodiment, user 100 may interact with the invention by way of client PC with a LAN connection to the various components of SNS 110.

Web client 105 comprises any hardware and/or software suitably configured to facilitate input, receipt and/or review of any information related to SNS 110 or any information discussed herein. In one embodiment, a web client 105 may include a browser application installed on any device (e.g., kiosk 175, set-top box 180, and wireless device 165), which communicates (in any manner discussed herein) with the invention via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, workstations, computer-servers, main frame computers, mini-computers, PC servers, pervasive computers, network sets of computers, and/or the like. Practitioners will appreciate that web client 105, kiosk 175, set-top box 180, and wireless device 165 may or may not be in direct contact with SNS 110. For example, web client 105 may access the services of SNS 110 through another server, which may have a direct or indirect connection to web server 120.

As those skilled in the art will appreciate, web client 105, kiosk 175, set-top box 180, and wireless device 165 may each include an operating system (e.g., WINDOWS NT, 95/98/2000/Vista, OS2, UNIX, LINUX, SOLARIS, MAC OS, etc.) as well as various conventional support software and drivers typically associated with computers. A connecting device may include any suitable personal computer, network computer, workstation, minicomputer, mainframe or the like. As will be disclosed herein, the connecting device may be in a home, neighborhood, school, public facility, or business environment with access to a network. In an exemplary embodiment, access is through a network or the Internet through a commercially available web-browser software package as described above.

Web client 105, kiosk 175, set-top box 180, and wireless device 165 may each be independently, separately or collectively suitably coupled to the network via data links which includes, for example, a connection to an Internet Service Provider (ISP) as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The invention contemplates uses in association with web services, utility computing, pervasive and individualized computing, security and identity solutions, autonomic computing, commodity computing, mobility and wireless solutions, open source, service oriented architecture, biometrics, grid computing and/or mesh computing.

Web server 120 may include any hardware and/or software suitably configured to facilitate communications between a connecting device (e.g., web client 105, kiosk 175, set-top box 180, wireless device 165) and one or more SNS 110 components. Further, web server 120 may be configured to transmit data to a connecting device within markup language documents. Web server 120 may operate as a single entity in a single geographic location or as separate computing components located together or in separate geographic locations. Requests originating from a connecting user 100 may pass through a firewall 115 before being received and processed at web server 120. As used herein, “transmit” may include sending electronic data from one system component to another over a network connection. Additionally, as used herein, “data” may include encompassing information such as commands, queries, files, data for storage, and the like in digital or any other form. Web server 120 may provide a suitable web site or other Internet-based graphical user interface which is accessible by user 100, or any other authorized third party. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.98). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Router 179 comprises any hardware and/or software suitably configured to direct network traffic to the appropriate SNS 100 component and/or user 100 device (e.g. kiosk 175, web client 105, set-top box, and wireless device 165). Specifically, router 170 operates to determine the next network point to which a data packet (request) should be forwarded in order to reach its destination. Router 170 communicates with at least two networks (e.g., WAN and wireless network) and determines which way to send each data packet based on the state of the networks it is connected to. Router 170 creates and maintains information relating to available routes and uses this information to determine the best route for a given data packet.

Data that is transmitted to or received from router 170 may pass through a firewall 115. In one embodiment, firewall 115 comprises any hardware and/or software suitably configured to protect SNS 110 components from users of other networks. Firewall 115 may reside in varying configurations including Stateful Inspection, Proxy based and Packet Filtering among others. Firewall 115 may be integrated as software within web server 120, any other SNS 110 component, or may reside within another computing device or may take the form of a standalone hardware component.

In one embodiment, applications server 135 includes any hardware and/or software suitably configured to serve applications and data to a connected device. Like web server 120, applications server 135 may communicate with any number of other servers, databases and/or components through any means discussed herein or known in the art. Further, applications server 135 may serve as a conduit between a connecting device and scheduling utility 155. Web server 120 may interface with applications server 135 through any means discussed herein or known in the art including a LAN/WAN, for example. Application server 135 may further directly and or indirectly interact with authentication server 125, user database 130, activities database 145, messaging gateway 150, router 170 or any other SNS 110 component in response to requests from web client 105, kiosk 175, set-top box 180, and wireless device 165.

Scheduling utility 155 includes any hardware and/or software suitably configured to provide event scheduling and maintenance tasks through interaction with the various SNS 110 components. Scheduling utility 155 may comprise any number of software procedures and functions providing database access for the purposes of, for example, retrieving activities information, retrieving calendar entries, retrieving advertising information, creating invitations, creating announcements, saving event information, maintaining participant data, processing payments, and the like. In one embodiment, scheduling utility 155 manages synchronization procedures between activities database and a calendaring system of user 100. Such calendaring systems may include, for example, Microsoft Outlook™, Lotus Notes™, Palm™, Blackberry™, etc.

SNS 110 may further include a report engine (not shown). Report engine includes any hardware and/or software suitably configured to produce reports from information stored in one or more databases. Report engines are commercially available and known in the art. Report engine provides, for example, printed reports, web access to reports, graphs, real-time information, raw data, batch information and/or the like. Report engine may be implemented through commercially available hardware and/or software, through custom hardware and/or software components, or through a combination thereof. Further, report engine may reside as a standalone system within SNS 110 or as a component of web server 120. The reports may include the attendees or non-attendees at certain activities, cancellation statistics, attendance statistics and the like.

To control access to web server 120 or any other component of the invention, web server 120 may invoke authentication server 125 in response to submission of authentication credentials received at web server 120. In one embodiment, authentication server 125 includes any hardware and/or software suitably configured to receive authentication credentials, encrypt and decrypt credentials, authenticate credentials, and/or grant access rights according to pre-defined permissions attached to the credentials. Based on permissions granted to user 100, scheduling utility 155 manages access to other SNS 110 internal and/or external systems. Access to such systems may be necessary in order to allow user 100 to participate with the various aspects of the invention as disclosed in greater detail herein.

Authentication server 125 may grant varying degrees of application and data level access based on user information stored within user database 130. In one embodiment, authentication server 125 may be accessed by scheduling utility 155 in order to validate signals received by messaging gateway 150 from a wireless network 160.

As used herein, wireless network 160 may comprise any number of computing systems, relays, switches, radio towers, and satellites in order to provide wireless communications between any number of subscribing members. Those skilled in the art will appreciate that such systems are well known, and variations and advancements to the underlying technologies do not limit the scope of the invention. The invention contemplates that such networks may include, for example, land based RF transponders and satellites in low earth orbit to provide voice and data transmissions between a number of both stationary and portable devices.

In one embodiment, the various databases disclosed herein (e.g., user database 145 and activities database 145) include any hardware and/or software suitably configured to facilitate storing authentication and/or privilege information relating to users. One skilled in the art will appreciate that the invention may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The software elements of the present invention may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

As will be described in greater detail in reference to the figures, the present invention includes SNS 110 in networked communication with an SNS terminal (connection device). In one embodiment, a SNS terminal connects directly to SNS 110. In another embodiment, a SNS terminal connects to a location server, which in turn, connects to SNS 110. In an exemplary embodiment, the user interface comprises a box or station either permanently or removably installed or located in a static location, for example, in a wall, on the ground, or on a table-top, such that a touch screen is visible to the user. The user interface provides, in one embodiment, a menu based system which is navigable through the touch screen monitor for suggesting, accepting or inquiring about activities posted by other users. In one embodiment, the user interface is coupled to a location server, for example, through a wireless network 160, through the Internet, through a local area network, through a local intranet, though telephone lines, or any other communication or network discussed herein or later developed.

According to an exemplary embodiment of the invention, the SNS terminal is set-up as a station or bulletin-board in a common area of the community where the location server administers the network. As used herein, SNS terminal refers to the kiosk 175, web client 105, set-top box 180, and wireless device 165 according to the various embodiments of the invention. Where the SNS terminal user interface is accessible by a number of users, the interface requests a unique user ID and password to access the network. In a further embodiment of the invention, the user interface may provide an access point for alternative positive identification, such as a retinal scanner, a fingerprint scanner, a magnetic card reader, a Radio Frequency Identification (“RFID”) tag reader, or other biometric scanners known in the art or later developed.

In yet another embodiment, any component of the system may be configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The user interface may display and/or synchronize a user's SNS terminal calendar with their pre-existing, external meeting scheduling software (i.e., Microsoft Outlook or Lotus Notes). In an exemplary embodiment, the user interface displays a search dialogue for new users. The search dialogue allows the user to search activities database 145 for activities existing in the geographic area of the network. Activities database 145 may also include information on popular activities chosen by other users on the geographic network, thus facilitating appropriate choices for activities that would interest larger numbers of users. According to other embodiments, the databases may comprise locations, restaurants or events in any number of pre-existing or custom created databases.

The user interface also provides, in one embodiment, an opportunity to display ambient advertising or other content (e.g., as determined by the Location Server or User) on SNS terminal display screens while not in active use or on the device. In conjunction with the advertising or other content, a particular location or establishment is recommended to a user to set up a meeting and send out an invitation. A further embodiment of the invention provides a portal for users to purchase, for example, travel arrangements, pharmacy medications, theater tickets, sporting event tickets, gifts, etc. Additionally, the SNS terminal displays other items on the user interface located in common areas, for example a video connection to a shared building outside door, garage, security desk, hallway, etc. In yet another embodiment, the user interface communicates with a pre-existing or new communications device, for example, a building intercom, in-home stereo or security system.

According to an exemplary embodiment, the SNS terminal user interface communicates with scheduling utility 155. Scheduling utility 155 communicates with the Internet, a local area network, a telecommunications network, a local wireless network, a satellite communications network, a community intranet, or any other networked discussed herein, such that information is transmitted between any of the user interfaces (e.g., kiosk 175, web client 105, set-top box 180, and wireless device 165), SNS 110, and a location server. According to one embodiment (not shown in FIG. 1), SNS 110 provides product updates, location updates, user updates, activity updates and the like to a location server. In an embodiment of the invention, SNS 110 performs background checks on new users to determine if they are safe users. Additionally, the SNS 110 hosts databases, as discussed above, such as a database of all users on all SNS terminal location servers, a database of all location (geographic) information on all location servers, a database of all Suggested Activities on all location server locations, a database of all items to be sold at all location server areas, a secure database of all customer identification information, comprising financial account number for use in consumer transactions on the user interface. The main network server also hosts web sites which enable, for example, users and administrators to access various types of information and maintain the databases.

In an exemplary embodiment of the invention, each SNS terminal user interface communicates with SNS 110 via a location server. In various embodiments, the location server performs one or more of the following functions: communicates with the Internet, a local area network, a telecommunications network, a wireless network, a satellite network, a community intranet, etc.; receives product, user, activity, etc. updates from SNS 110; update SNS 110 databases (e.g., user database 130 and activities database 145) with new user information and/or activity information; receives updates for and updates software for connected SNS terminal devices; hosts a plurality of databases, for example, a database of users approved for the specific location, a database of location information, a database of suggested activities for the particular location, a database of all items that are sold or offered for sale at a particular location; provides a portal to connect to other display functions for common use areas (e.g., a video connection to a shared building outside door, garage, security desk, or hallway); broadcasts and receives signals to all connected SNS terminal devices, thereby updating the devices as to what suggested activities are available and how many users will be participating.

Each SNS terminal device, in an exemplary embodiment, is capable of communicating with a local server via a wireless, satellite or other connection discussed herein, thus facilitating easier installation in new locations and facilitating portability of the user interface. Each local server may also connect to SNS 110 via a wireless and/or satellite connection, facilitating operation of local network servers in remote locations.

In an exemplary embodiment, when not in use, the SNS terminal device displays either ambient advertising selected by the Location Server based on, for example, the users prior activity selections or scheduled merchant requests. The device may also display shared resources of a building or an area. For example a video, audio and video, or only audio connection to a shared building door, garage, hallway, driveway, security desk, etc. The device may also display photos, videos, movies and/or television stations as selected by the Location Server and based on, for example, the users prior selections. These features may also be displayed when the device is in use by being displayed in a split screen, pop-up window, separate window, separate monitor, and/or the like.

In a further embodiment, if the security feature for log-in is set by the location server, activation of the user interface or station using the touch screen interface promptly displays a log-in screen requesting a unique user ID and password. This functionality may be supplemented or replaced with retinal scanning, fingerprinting, magnetic card swiping, RFID tags or any other form of identification or biometric identification as discussed above.

After successful log-in to the user interface, according to an exemplary embodiment, a question based menu system is displayed allowing a user to perform one or more of the following functions. User 100 may join a previously suggested activity which may include a display of all events suggested by other SNS terminal users connected to that location server. If an event invitation is accepted, activities database 145 is updated to include this new user 100. All SNS terminal devices and stations connected to this location server are then updated with the new number (and potentially names or aliases) of attendees for this event.

The system may allow a user to suggest a new activity. This option would allow the user to suggest a new activity to upload to the database. Once uploaded to the database, this activity is then displayed to all (or a subset of) other users on that location network on the individual user interfaces. In a further embodiment, users may restrict the users to whom this suggestion was broadcast through pre-defined lists. Accordingly, and as disclosed in greater detail herein, a suggestion may be broadcast to a defined demographic of the network. For example, when suggesting a singles movie night, user 100 may limit the distribution to single members between the ages of 30 and 45.

The system may automatically suggest an activity. The SNS terminal may select a location or establishment based on one or more of user's 100 inputs, if user 100 has previously input a particular interest in an activity, if user 100 has participated a certain number of times in a certain activity previously, if particular activities are popular in a certain local area, etc. In certain embodiments, the SNS terminal may select a random location or establishment, or select a location or establishment based on sponsors or advertisers, if the user has specifically allowed this functionality or if the functionality is under a default setting.

SNS 110 may search the SNS terminal network for locations, restaurants, products, events, travel arrangements or even other SNS terminal users on a certain location server. The main network and local network has the additional functionality, according to one embodiment, such that sponsoring parties could request (e.g., for a fee) that their locations, events, products or restaurants be indicated as “preferred” which would display those locations, events, products or restaurants first on user searches or include a special icon or other notation to specially identify it.

The system may allow the viewing of alternative resources. This option provides a portal for users to view shared resources of a building or an area, for example, a video, audio and video, or audio-only connection to a shared building door, garage, hallway, driveway, security desk, etc. Additionally, the user interface displays photos, videos, movies and/or television stations, for example, as selected by the location server and/or based on the users prior selections. In a further embodiment, the user interface connects to a pre-existing or new communications device such as a building intercom, an in-home stereo, an in-home or community security system, etc.

SNS 110 may also display local, national, and/or world news. The SNS terminal system could provide users with news updates either based upon their pre-selected settings or those set at the location server level. Location server administrators could also provide site-specific news updates to broadcast to the SNS terminal devices. SNS terminal users could provide their own news updates to display to users they select through their pre-defined user lists.

SNS 110 may also display a users SNS terminal calendar. This could potentially be combined with their pre-existing, external meeting scheduling software (ie, Microsoft Outlook or Lotus Notes).

In another embodiment, the user interface generates and maintains a database of SNS terminal lists. Users create lists of other SNS terminal users for their location server. Any number of lists are created by any given user 100 within potential restrictions based on location server and SNS 110 capabilities and functionality. These lists may be used to limit the number of people who can see and/or accept the event invitations

In still another embodiment, the user interface provides event notifications. The SNS terminal system updates users of upcoming events via email, text message, voice mail or some other medium. This functionality is based on an individual user's pre-selected preferences and/or location server pre-selected preferences. Notifications are also sent if there is a change to the original suggested event. If a user's alternate, pre-existing, external meeting scheduling software (e.g., Microsoft Outlook or Lotus Notes, for example) was set-up to synchronize with the SNS terminal and a conflict was found, a notice is displayed or sent to user 100.

According to a further embodiment, the user interface provides financial services in conjunction with the location server and SNS 110. The SNS terminal system may store users' bank account or credit card information including account numbers allowing the users to purchase travel, dining or other products or arrangements directly through the system. This purchasing capacity could be integrated into an existing billing system for a neighborhood, club, building or school. In conjunction with this functionality, the SNS terminal system allows users to also search through products, tickets, food items or other items to purchase or order through pre-determined online retailers.

In conjunction with the financial services, an exemplary embodiment provides a loyalty program, incentive program, and the like for users of the SNS terminal network. A user may receive loyalty points for setting up a particular event, making a purchase, transacting business, etc. using the SNS terminal device. The loyalty points may be used towards any future transaction using the SNS terminal device or any other merchant or within any other loyalty system. Loyalty points may also be tied to the specific activity for which the points were earned. A user may earn points for setting up an activity. Each user who attends an activity may also earn points. In a further embodiment, all users on a particular network may receive points for a certain activity. Additionally, if an activity is coordinated between two different location servers, e.g. two different apartment complexes, then all users of both location servers may receive points, for example, to encourage such inter-network activities. Also, user 100 may earn additional loyalty points for buying products that are advertised on the user interface, and may earn more points for buying on other local networks.

In order to maintain safety, the user interface in conjunction with the location server and SNS 110 may perform background checks on new users and periodically run background checks on current users. Users could be screened through a background checking service to determine if they are “safe” users. For example, the system may interface with or obtain data from criminal records, employment or business data, credit checks, civil litigation checks, other memberships, etc. Users who suggest events or receive notifications of events may be required or requested to include this safe designation. Users may also be required or requested to obtain the ‘safe’ designation before accepting any invitations.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The system can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the steps described herein may comprise any number of configurations including the use of windows, web pages, web forms, popup windows, prompts and the like. It should be further appreciated that the multiple steps as described may be combined into single web pages and/or windows but have been expanded for the sake of simplicity. In other cases, steps illustrated and described as single process steps may be separated into multiple web pages and/or windows but have been combined for simplicity.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts, text messages, and the like. It should be further appreciated that the multiple steps as illustrated and described may be combined into single web pages and/or interfaces but have been expanded for the sake of simplicity. In other cases, steps illustrated and described as single process steps may be separated into multiple web pages and/or interfaces but have been combined for simplicity.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

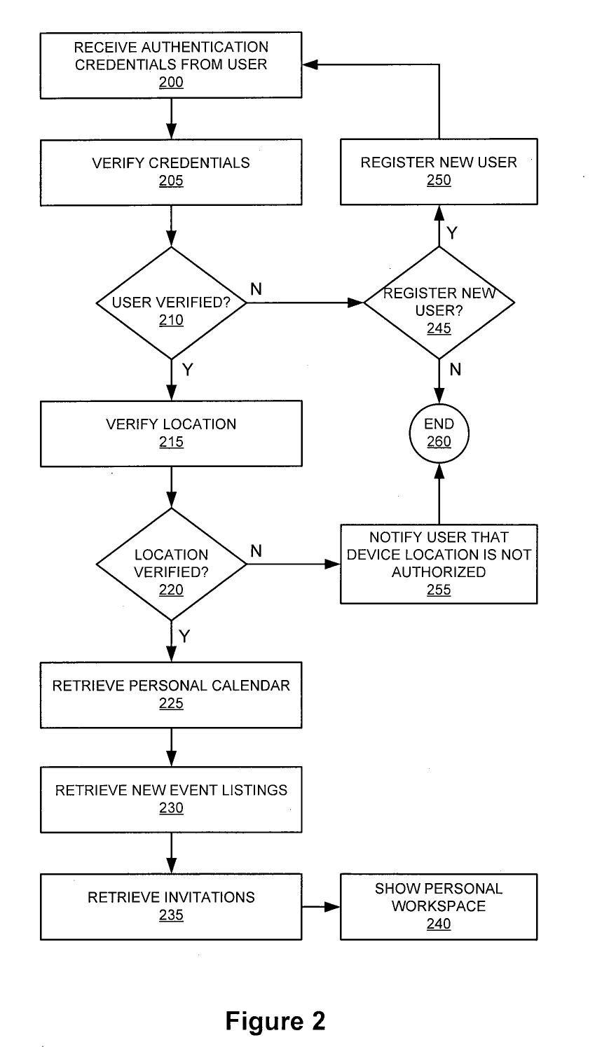

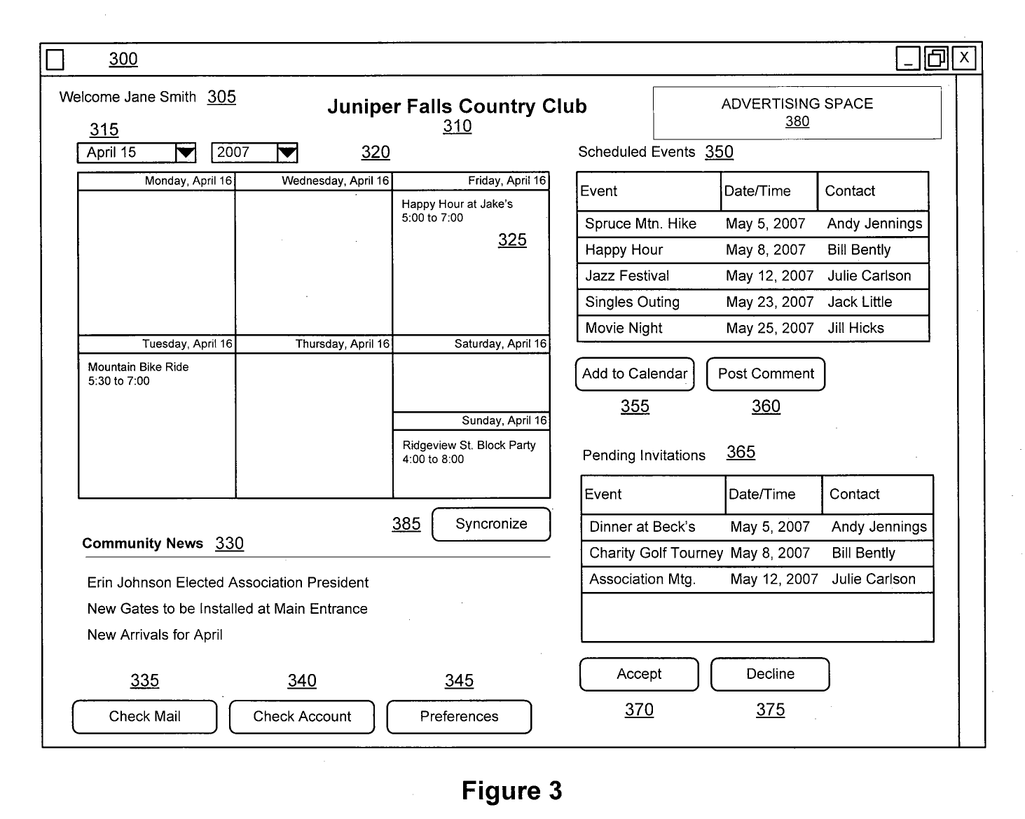

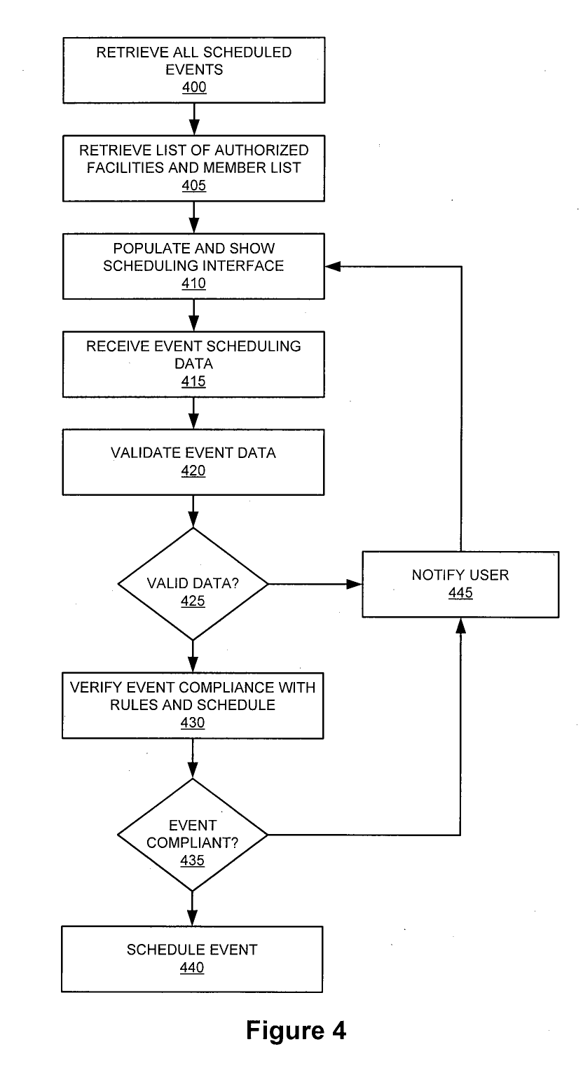

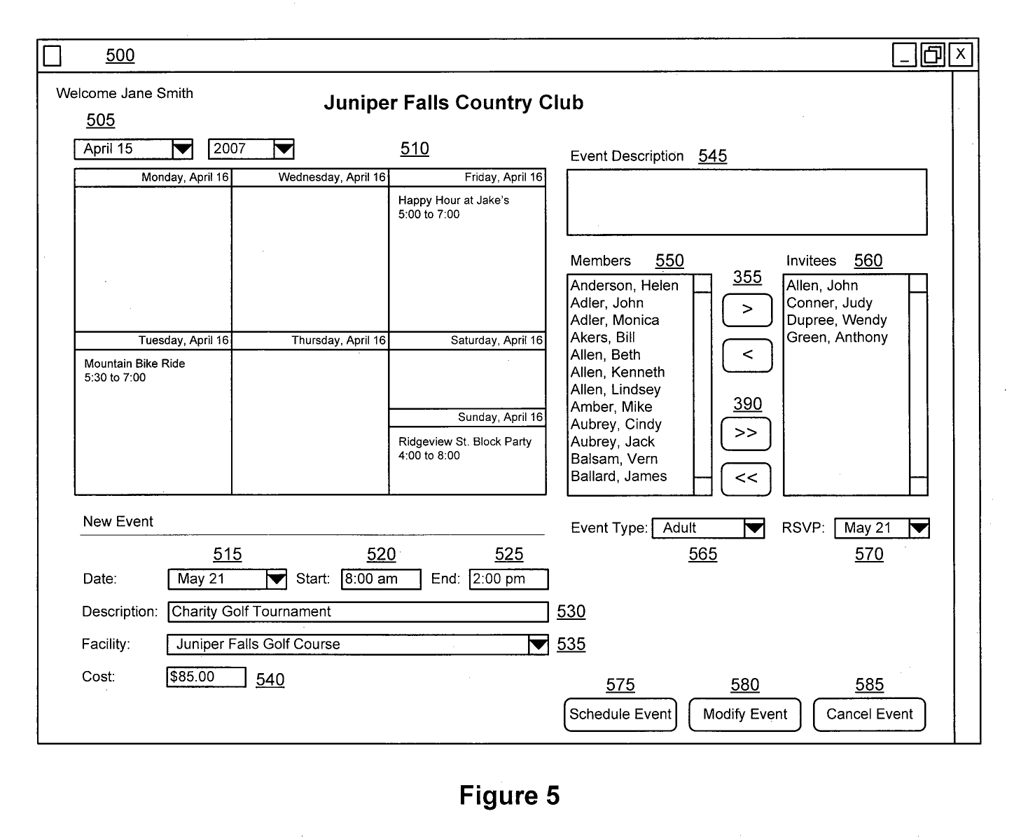

Referring now to the figures, the block system diagram and process flow diagram represent mere embodiments of the invention and are not intended to limit the scope of the invention as described herein. For example, the steps recited in FIGS. 2 and 4 may be executed in any order and are not limited to the order presented. Furthermore, the user interface elements of FIGS. 3 and 5 may be presented in any arrangement and may include more or less elements than is shown. It will be appreciated that the following description makes appropriate references not only to the steps and screen shots depicted in FIGS. 2-5, but also to the various system components as described above with reference to FIG. 1.

With reference to FIG. 2, user 100 may interact with a SNS terminal interface to perform a variety of functions as will be described herein. User 100 enters unique authentication credentials into the SNS terminal interface. Practitioners will appreciate that such authentication credentials may comprise a user identifier, password, PIN, smart card radio frequency device, biometric read, or any combination thereof. Authentication credentials may be entered into a keyboard attached to the SNS terminal, entered into a touch screen keyboard, entered by way of an RF reader, smartcard reader, biometric reader, and the like.

Authentication credentials are transmitted from the SNS terminal to SNS 110 where they are received and processed (step 200) by authentication server 125. Authentication server 125 issues a query against user database 130 to verify the authentication credentials against stored records for registered users (step 205). If the authentication credentials are not verified (step 210), then user 100 is notified via SNS terminal and is prompted to register as a new user. If user 100 does not choose to register as a new user (step 245), the authentication process ends (step 250). However, if user 100 selects an option to register with SNS 110 (step 245), the user 100 is presented with a registration form (step 250). Any other step or component of known online registration processes may also be included. In one embodiment, user 100 enters location or affiliation information in order for SNS 110 to determine the user's eligibility and/or associate user 100 with a specific location server.

If the authentication credentials for user 100 are verified (step 210), then scheduling utility 155 verifies user 100 location (step 215). Various technologies and methods maybe implemented in order to identify a user's location including, for example, a terminal identifier, a client identifier, Global Positioning System (GPS), and the like. Location information may relate to the user's physical location when accessing SNS 110 or more generally to a geographic location for a social network that user 100 has been assigned. For example, a social network may be configured for residents in a master-planned community. If the master-planned community installed an SNS terminal in the community recreation center, then SNS 110 verifies that user 100 is accessing SNS 110 through the proper SNS terminal. In another embodiment, location may relate to the user's affiliation. For example, a social network may be configured for the employees of a large corporation; therefore, members may reside in a wide variety of geographic locations. Thus, the social network is defined by an affiliation with the identity of the corporation.

If user 100 attempts to access SNS 110 from an unauthorized location or is not affiliated with the social network that he is attempting to access (step 220), then SNS 100 transmits a message to the SNS terminal notifying user 100 that access to the location and/or selected affiliation is not authorized (step 255). Web server 125 aborts the network session and the process ends (step 260). If the location or affiliation is verified, then scheduling utility 155 is invoked to retrieve calendar data relating to user 100 (step 225). Calendar data includes information relating to registered activities and events, as will be described in greater detail in reference to FIG. 3. Scheduling utility 155 further retrieves information from activities database 145 relating to new event listings (step 230). New event listings may include, for example, events and activities that other members of the social network have planned and are available for users to participate. Scheduling utility 155 also retrieves invitations specifically relating to user 100 (step 235). Users may schedule events and activities that are available to all users belonging to the social network. A scheduling user may also configure activities such that only selected network users are invited to participate. When the above information is retrieved from activities database 145, it is transmitted to the connected SNS terminal where it is displayed within a personal workspace interface (step 240).

The personal workspace, as shown in FIG. 3, enables user 100 to manage their personal social activities within a social network. The interface may be presented in relation to the type of device used to access and interact with SNS 110. For example, if the connecting device is a kiosk 175, the interface may include large interface elements to enable user 100 greater control through a touch-screen. However, if the connecting device is a cellular telephone or personal digital assistant, interface elements may be configured to enable larger amounts of data to be viewable from a small LCD screen, or the interface may be divided between two or more specific interfaces.

The personal workspace 300 may include a personalized greeting 305 to ensure user 100 that she is viewing the proper workspace. Moreover, the personal workspace may include a heading 310 identifying the specific social network. In one embodiment, the personal workspace includes a calendar 320 that displays the current day, week, or month by default. This provides user 100 with an immediate view of registered events that are occurring in the near future. In one embodiment, the calendar view may be modified according to the user's needs and/or preferences 345. User 100 may select a different timeframe to view through one or more dropdown menus 315, where a desired day, week, month, or year may be selected. Calendar entries may be modified by selecting a cell within the calendar, which opens an interface providing editing functionality. For example, if user 100 desires to modify the description for an event scheduled for Friday, April 16, then user 100 may select the calendar cell 325; launching a calendar editing interface.

Personal workspace 300 further includes a table listing events that have been scheduled within the social network 350. The scheduled events table 350 lists those events that are open to all qualified members of the social network. In another embodiment, the scheduled events table 350 displays events that are both open to all members of the social network and only events that user 100 is qualified to participate in. Scheduled events table 350 may be filtered based on any criteria discussed herein. The filter may be implemented by the user, the host, administrator, event coordinator, or any other third party. The filtering may also be automatically based upon personal profile information, or previously selected (or non-selected) events. For example, user may request that user receive scheduled events related to music and hiking, but not events related to Happy Hour. The scheduled events table 350 lists a short event description, event date and time, and an event contact. An event contact may be the user that scheduled the event or a contact that has been designated by the scheduling user. Practitioners will appreciate that the scheduled events table 350 may include any level of detail to sufficiently provide desired event information. In one embodiment, user may define the level of displayed detail through configuration of preferences 345.

In one embodiment, members or other third parties may advertise products and/or services within selected events and/or event time slots. Such advertising provides members with the ability to advertise to precise demographics and/or according to the likely needs that participants would have. For example, a babysitter who is available on Friday nights may add a description of her services to selected events occurring on Friday nights. Moreover, a member may advertise according to time slots, without regard to the event type. Thus, the babysitter may interact with SNS 110 to have her services listed for all events occurring within a defined timeslot. Moreover, members who have purchased goods and/or services from advertisers may post a rating and/or comment relating to the advertiser. This enables other members of the network to determine whether or not to purchase goods and/or services from the advertiser. For example, a member may rate the services of a babysitter as “excellent”, thereby providing other members with a degree of confidence when selecting the babysitter.

Advertisers may also select the total number of patrons that they may accommodate within a defined timeslot. For example, a local tennis pro may advertise group tennis lessons and define a maximum number of 10 openings. Subsequently, if demand for the tennis pro's services reached 18 interested participants, then SNS 110 provides the tennis pro with a second suggested time slot to schedule another group session. In one embodiment, the tennis pro may configure SNS 110 such that possible additional time slots are predefined. As such, SNS 110 may automatically schedule a second session if demand exceeds a defined threshold. For example, the tennis pro may interact with SNS 110 to advertise his tennis lessons for 7:00 pm on Fridays with a maximum class size of 10. He may further define that if demand for his services reaches 18, then a second session will be scheduled for 6:00 pm on Saturday. The system may continue to advertise the services of the tennis pro until the maximum number of participants and sessions have been met. Any other limitations, groupings or restrictions may be added to the group session selection process (e.g., only women, men over 50 years old, etc).

User 100 may add any one or more scheduled events to their personal calendar. For example, user 100 may select table cells corresponding to the event to add to the calendar and select an “Add to Calendar” button or link 355. Scheduling utility 155 verifies that the event does not interfere with any other events on the user's calendar and adds the event to the appropriate date/time slot of the calendar 320. In one embodiment, scheduling utility 155 transmits a confirmation email to user 100. Scheduling utility 155 may further transmit a notification email to the event contact to enable the contact to monitor event responses. In another embodiment, scheduling utility 155 interacts with a report engine (not shown) to generate a detailed report relating to event registration. Such a report may be provided to the event contact at regular intervals prior to the event date, or may be made available on request from the event contact.

User 100 may also post a comment relating to a scheduled event. The comment may be appended to the event column in the scheduled events table 350, emailed to the event contact, or posted to a discussion thread of a forum relating to the event. Commenting enables users of the social network to exchange ideas and/or suggestions relating to a particular event or group of events. For example, user 100 may be aware of a good location to hold a Happy Hour gathering. User 100 may select a “Post Comment” button 360 to enter the suggestion, which may be made available to the event contact, or made available for other users on the network to view and/or respond. In one embodiment, comments may be viewable to the event scheduler only. In another embodiment, a user posting a comment may designate whether the comment is viewable by all users of the social network, a subset of users, or the event scheduler only.

SNS 110 enables network users to schedule events that are available to other network users by personal invitation. For example, a home owner within a master-planned community social network may schedule a dinner party for other homeowners in the network based on close friendships with other homeowners. As such, the homeowner may schedule a dinner party event and invite only select network members (as will be discussed in greater detail in reference to FIG. 5). When such an event is scheduled and the user is invited to such event, it will appear in a pending invitations table 365 of the personal workspace interface 300. User 100 may view details relating to pending invitations including, for example, an event description, a date and time for the event, and the event contact. Again, practitioners will appreciate that the pending invitations table 365 may include more or less information than what is shown. Pending invitations table 365 may be filtered based on any criteria discussed herein. The filter may be implemented by the user, the host, administrator, event coordinator, or any other third party. The filtering may also be automatically based upon personal profile information, or previously selected (or non-selected) events. Moreover, the level of detail shown in the pending invitations table 365 may be modified by selecting a “Preferences” button or link 345 to open a configuration interface.

To accept a pending invitation, user 100 selects an event invitation from the pending invitations table 365, and selects an “Accept” button or link. In one embodiment, User 100 may add a comment to the invitation acceptance. When an invitation is accepted, SNS 110 verifies that the event will not interfere with any other events in the user's calendar. If the event does not interfere, the event is added to the appropriate date/time slot of the user's calendar 320 and is removed from the pending invitations table 365. User 100 may also decline an invitation by selecting an event in the table and selecting a “Decline” button or link. In one embodiment, scheduling utility 155 prompts user 100 to optionally enter a reason for declining the invitation. Scheduling utility 155 may further transmit a confirmation email to user 100 and a notification email to the event contact to enable the contact to monitor event responses. In another embodiment, scheduling utility 155 interacts with a report engine (not shown) to generate a detailed report relating to event registration. Such a report may be provided to the event contact at regular intervals prior to the event date, or may be made available on request from the event contact.

In one embodiment, user 100 may synchronize a personal calendaring system with the SNS 110 calendar. Such personal calendaring systems include PC based software including, for example, Microsoft Outlook and Lotus Notes. Other calendaring systems are built into handheld devices such as a Personal Digital Assistant and a cellular telephone. The invention may enable such portable devices to connect to SNS 110 through an infrared connection, radio frequency, Ethernet cable, and any other known connectivity methods. When connected, user 100 may access the personal workspace 300 and select a “Synchronize” button or link to initiates a data transfer between a portable device or PC and activities database 145. Practitioners will appreciate that there are any number of public and proprietary system for facilitating the transfer and formatting of data from one calendaring system to another.

Because the social network of the invention groups individuals of like geographic locations, interests, beliefs, gender, age, profession, employment, religion, race, etc., personal workspace 300 may further include community news 330. Community news may present information that would be of interest to the user's specific social network. Also, personal workspace 300 may provide advertising space 380 to enable business owners to closely target their prime demographic by selecting specific networks to place advertising. Moreover, social network members may own businesses that they would like to bring to the awareness of other members of their network.

In one embodiment, an interface is provided to enable network members to rate or comment on an event that the member has participated in, or the people that attended the event. In this way, other members may determine whether or not to participate in an event based on individual or collective member ratings and/or comments. For example, a member participating in a reoccurring happy hour event at a local sports bar may later return to the personal workspace to rate the event as “average”, or to post a comment stating that, “the venue was nice, however there was very little participation and a lack of conversation.” Moreover, event participants may rate and/or comment on event facilities. For example, an event participant may rate and/or provide a comment about the sports bar to indicate a low level of satisfaction. In one embodiment, individual and/or collective ratings may affect the facilities listing within the scheduling interface 500. The individual and/or collective ratings may affect the positioning of the facility in the list of available facilities 535 and/or an annotation appearing with the facility listing may provide scheduling members with an indication as to whether or not to use a facility for an event (e.g. color coding, stars, numbers, happy face, frowning face, etc.).

Users of a social network may interact with a scheduling interface in order to configure and schedule social events and meetings. Referring to FIG. 4, user 100 may select an option to schedule a new event after logging into SNS 110. Scheduling utility 155 performs a query to retrieve scheduled events from activities database 145 in order to populate a calendar (step 400). In one embodiment, only activities that are relevant to the logged in user 100 are retrieved. Scheduling utility 155 further queries activities database 145 to retrieve a complete or partial listing of available and/or approved event facilities and a complete or partial list of members of user's social network (step 405). Scheduling utility populates a scheduling interface with calendar data, facilities data, and member data and displays it at user's SNS terminal (step 410).

User 100 interacts with the scheduling interface to select an event date and time, select an event facility, enter an event description, select an event type, select an RSVP date, and/or add members to an invitees list. Each of these interactions will be described in greater detail in reference to FIG. 5. When the event has been properly configured, user 100 may transmit event data to SNS 110 where it is received and processed by scheduling utility 155 (step 415). Scheduling utility validates the format of the scheduling data to ensure compliance with system requirements (step 520). Such validation may include, for example, ensuring that date and time fields are in a proper format, checking for spelling errors, ensuring that event data is complete, and the like. If scheduling utility 155 is unable to completely or partially validate event data (step 425), then notification is transmitted to the SNS terminal (step 445). Notification may include a general or specific cause for the validation error along with instructions on how the error may be corrected. User 100 is presented with the populated scheduling interface to enable errors to be corrected (step 410).

Scheduling utility 155 further verifies that event data is compliant with predefined rules and with previously scheduled events (step 430). Such predefined rules may include, for example, whether any of the invited members do not fully or partially qualify for the event based on the selected event type. Thus, if scheduling utility 155 determines that an invited member is a child and the event type is “Adult”, for example, scheduling utility 155 will not schedule the event until the invitation list is corrected. The system also determines whether the event conflicts with any other scheduled event. For example, if the user attempts to schedule an event on the date and time of a neighborhood association meeting, scheduling utility may notify user 100 that the selected time slot is not available. If the event does not comply with predefined rules or conflicts with another scheduled event (step 435), the notification is transmitted to the SNS terminal (step 445). Notification may include a general or specific cause for the compliance error along with instructions on how the error may be corrected. User 100 is presented with the populated scheduling interface to enable errors to be corrected (step 410). If the event is compliant with predefined rules and does not conflict with other scheduled events (step 440), scheduling utility 155 formats the event data and saves it to activities database 145.

With reference to FIG. 5, users of a social network may access a scheduling interface 500 to facilitate the scheduling and management of events and activities. The scheduling interface 300 includes a calendar 510 that, in one embodiment, displays events that user 100 has registered, or elected, to participate in. In another embodiment, the calendar 510 displays all events that have been scheduled within a particular social network in order to allow a scheduling user to determine an optimal date and time to schedule an event. User 100 may select a different timeframe to view through one or more dropdown menus 505, where a desired day, week, month, or year may be selected.

To schedule a new event, user 100 selects an event date 515, start time 520, and end time 525. A short description field 530 enables user 100 to enter a general description for the event. For example, in scheduling a golf tournament, wherein proceeds will be donated to The American Cancer Society, user 100 may enter the abbreviated description, “Charity Golf Tournament”, as this will be the description other users will see within the scheduled events table 350 of their personal workspace 300. A more detailed description of the event may be entered in the “Event Description” field 545. Such information may include, for example, “Proceeds from this event will go to The American Cancer Society to aide in cutting edge cancer research. This year's sponsors include, Anderson Imports, Juniper Sports, and Dupree's Bar and Grill.” The detailed event description 545, as well as other event details may be viewable by other network users when they select the event from the scheduled events table 350. For example, double clicking on an event in the scheduled events table 350 may cause scheduling utility 155 to retrieve event details from activities database 145 and display the event details within a second interface.

A facility dropdown menu 535 is pre-populated with network approved and/or recommended facilities. For example, a social network comprising home owners within a master planned community may select facilities that are conveniently located relative to the neighborhood. The social network may further select facilities based on negotiated discounts with local businesses. As such, user 100 may select from a list of facilities that are available and/or capable of providing the venue for the event to be scheduled. In one embodiment, SNS 110 connects to selected facility providers such that user 100 is able to determine the facilities availability as well as rates and restrictions. Moreover, SNS 110 may interact with reservations systems at selected facilities to automatically schedule an event based on user 100 event scheduling.

When applicable, user 100 may enter an event cost 540. In one embodiment, SNS 110 connects to a payment processing system in order to receive and process charge card and/or debit card transactions from network users. Therefore, when scheduling an event, user 100 may select an option (not shown) to define accepted payment methods such as, for example, cash, check, and credit. If credit is selected as a payment option, then personal workspace 300 enables user 100 to enter charge card information when registering to participate in an event where a fee is required.

Member list 550 is pre-populated with the names of all members of a particular social network. Using a series of buttons and/or links 355, user 100 may build an invitation list for the event. User 100 may add members to an invitees list 560 by selecting a member name in the members list 550 and selecting a button or link to move the name from the members list 550 to the invitees list 560. Alternatively, user 100 may select a plurality of members from the members list 550 and select a button or link 355 to move all selected members from members list 550 to invitees list 560. If the event is open to all members in the social network, then user 100 may simply select button or link 390 to add all members from the members list 550 to the invitees list 560. Other buttons or links are provided to enable user 100 to modify the content of the invitee list 560 by removing member names.

Selecting an event type 565 enables invitees to determine whether they are able and/or willing to participate in a scheduled event. Event types may include, for example, “Adult”, “Family”, “Couples”, “Women”, “Men”, “Children”, “Teen”, “Singles”, “Guests Welcome”, etc. In one embodiment, user database 130 maintains information relating to each social network member that may be used to automatically determine when a member is qualified to participate in an event. For example, when scheduling an event where the event type 565 is “Adult”, SNS 110 may alert the scheduling user 100 when she attempts to add a juvenile member to the invitees list 560. In another embodiment, SNS 110 may populate the members list 550 based on a selected event type 565 to include only members that fall within the demographic for the event type.

SNS 110 may filter members according to any number of defined demographic criterions. Such criterions may be layered in order to filter down to a very specific list of members who may qualify to participate in an event. For example, a weekly poker event may be scheduled, wherein invitees are limited to men, between the ages of 40 and 55. Thus, filtering first considers the gender of each network member, and then considers the age of each network member in compiling a list of eligible members.

In one embodiment, scheduling user 100 may define a maximum number of participants for an event. For example, in scheduling a golf foursome, scheduling user 100 may restrict the event to three participants (in addition to the scheduling user). Therefore, as soon as SNS 110 receives event registration from the third network user, the invitation may be removed from the scheduled events list 350 and/or pending invitations list 365 of the personal workspace. Scheduling user 100 may further select an option to accept backup participants when an event becomes fully booked. Accordingly, the event may remain visible within the scheduled events list 350 and/or pending invitations list 365 of the personal workspace, however a notation or visible cue may be added to the event listing to indicate that the maximum number of participants have registered. In another embodiment, SNS 110 may alert a network member when attempting to register for a booked event. The alert provides the member with the options of whether or not to register as a backup participant. Thereafter, when a participant withdraws from an event, the next backup participant is selected and added to the list of event participants. The new participant may be notified by way of any of the notification methods disclosed herein.

In some instances, the number of available participant slots may be limited by external factors such as, for example, transportation, facilities, regulations, resources, staffing, and the like. In such cases, the SNS 110 may be configured to automatically add resources when the numbers of participants exceed event limitations. For example, when a member schedules a road trip where only four cars are available, the event may accept only 19 participants in addition to the scheduling user 100. However, if the 20^{th} member to register for the event indicates that she has her own automobile, SNS 110 may automatically open the event to an additional three participants. These participant may be added from a list of backup participants, or the event may be re-listed within the scheduled events list 350 and/or pending invitations list 365 of the personal workspace.

User 100 may select an RSVP date 570. This is a final date wherein invitees who wish to participate in the scheduled event may register to participate. When registration to participate in an event is not required, user may select a “NA” item from the RSVP dropdown menu 570. In one embodiment, a scheduled event is dropped from the scheduled events table 350 when the RSVP date is reached.

When an event has been configured, user 100 may select a “Schedule Event” button or link 575 which transmits the event information to scheduling utility 155. Scheduling utility 155 may validate the format of event data and perform a final check to determine whether the event complies with social network rules and whether the event conflicts with any other scheduled events. If the event data is validated and it is determined that the event complies with social network rules, the event is added to activities database. The scheduling interface further enables the user 100 to modify 580 or cancel 585 a previously scheduled event.

The interfaces illustrated in FIGS. 3 and 5 are presented for explanation only and are not intended to limit the scope of the invention. Any number and configuration of interfaces may be employed to carry out all or a portion of the functions disclosed herein. According to one embodiment, for example, an interface may enable network users to create tournament brackets and track tournament results over a period of time. When a registered participant drops out of an event or tournament, SNS 110 may automatically generate a request for a replacement. For example, SNS 110 may send an email notification or a post a notice within the personal workspace in order to fill the vacancy. Moreover, SNS 110 may perform an analysis on historical scheduling data and/or user profiles to determine users that have participated in like events in the past or who have an interest in the scheduled tournament and/or event. Another interface may enable network users to suggest activities and accept comments from other network users regarding the suggestion.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

I claim:

1. A computer-implemented method for managing a social network, said method including:
receiving a request indicative of a desire to participate in a social network and profile information associated with a first user;
creating a profile for said first user;
determining an eligibility of said first user to participate in said social network based on said profile and social network grouping criteria;
receiving, from said first user, event information relating to an event;
displaying said event information on a main calendar;
receiving a registration from a second user to participate in said event; and,
adding said event to a personal calendar of said second user.

2. The method of claim 1, further including displaying scheduled events, wherein said scheduled events are filtered based on at least one of: geographic area, age, gender, hobby, interest, relationship status, family status, profession, memberships, education, financial status, race, religion, and event type.

3. The method of claim 2, wherein said filtering is implemented by at least one of: said first user, said second user, a host, an administrator, an event coordinator, and any other third party.

4. The method of claim 2, wherein said filtering is performed automatically based upon at least one of: personal profile information, previously selected, and non-selected events.

5. The method of claim 1, further including receiving a comment relating to said event from said second user, wherein said comment is viewable by at least one of: said first user, all users of said social network, and a subset of users of said social network.

6. The method of claim 1, further including displaying a request for a replacement user when said second user cancels said registration to participate is said event.

7. The method of claim 1, further including synchronizing said main calendar with said personal calendar.

8. The method of claim 1, further including performing an event search based on search criteria received from said second user.

9. The method of claim 1, further including receiving a request for a purchase from said second user.

10. The method of claim 1, further including sending a confirmation of said registration to said first user by way of at least one of: email, instant message, text message, facsimile, postal mail, and telephone call.

11. The method of claim 1, further including notifying said first user when said registration is received from said second user.

12. The method of claim 1, further including receiving an event recommendation from said second user.

13. The method of claim 1, further including performing a background check on said second user.

14. The method of claim 1, wherein said social network is created by grouping members according to at least one of: geographic area, age, gender, hobby, interest, relationship status, family status, profession, memberships, education, financial status, race and religion.

15. The method of claim 1, wherein at least one of: said second user interacts with said social network by way of at least one of: a kiosk, a web client, a set-top box, and a wireless device.

16. The method of claim 1, wherein said adding said event to a personal calendar of said second user is dependent on a predefined rule.

17. The method of claim 1, wherein said adding said event to a personal calendar of said second user is dependent on meeting participation criteria defined for said event

18. The method of claim 1, further including generating a report based on registration data relating to said event.

19. The method of claim 1, further including scheduling a tournament and tracking results of said tournament.

20. The method of claim 1, further including listing a scheduled event, wherein said second user selects an event from said listing to add to said personal calendar.

21. The method of claim 1, further including listing a pending event invitation, wherein said second user selects said pending event invitation from said listing to add to said personal calendar.

22. The method of claim 1, further including listing an available facility based on a type of said event.

23. A computer readable storage medium containing a set of instructions for a general purpose computer for managing a social network, said instructions including:
receiving a request indicative of a desire to participate in a social network and profile information associated with a first user;
creating a profile for said first user;
determining an eligibility of said first user to participate in said social network based on said profile and social network grouping criteria;
receiving, from said first user, event information relating to an event;
displaying said event information on a main calendar;
receiving a registration from a second user to participate in said event; and,
adding said event to a personal calendar of said second user.
